(19) United States
(12) Patent Application Publication
(10) Pub. No.: US 2022/0349916 A1
(43) Pub. Date: Nov. 3, 2022

(54) NANOSCALE IMAGING SYSTEMS AND METHODS THEREOF

(71) Applicant: OptiPro Systems, LLC, Ontario, NY (US)

(72) Inventor: James Fredric Munro, Ontario, NY (US)

(73) Assignee: OptiPro Systems, LLC, Ontario, NY (US)

(21) Appl. No.: 17/735,863

(22) Filed: May 3, 2022

Related U.S. Application Data
(60) Provisional application No. 63/183,410, filed on May 3, 2021.

(51) Int. Cl. G01Q 60/22; G01Q 70/08

(52) U.S. Cl. CPC G01Q 60/22; G01Q 70/08

(57) ABSTRACT

An imaging system includes a probe device configured to make displacement measurements of a sample. A mounting stage to support the sample, where at least one of the probe device or mounting stage comprises a rotatory actuator that rotates the one of the probe device or mounting stage. A processing system is coupled to at least one of the probe or the mounting system and comprises a memory coupled to a processor configured to be capable of executing programmed instructions to: initiate the displacement measurements with the probe device; initiate with the rotary actuator a change in a rotational position of the sample for the displacement measurements; determine a lateral position of features of the sample based on the displacement measurements and the different rotational positions; and generate an image of the sample based on the determined lateral position of the features.

### BACKGROUND

This application claims the benefit of Provisional Patent Application Ser. No. 63/183,410, filed May 3, 2021, which is hereby incorporated by reference in its entirety.

### FIELD

The technology generally relates to systems and methods for generating an image of a surface or the interior of a volume with nanometer-scale resolution, and, furthermore, for numerically determining the location of features of the sample with nanometer-scale precision.

Conventional lens-based microscopes are typically limited in their ability to resolve lateral (in-plane) features of a specimen to about one-half of the wavelength of the light being imaged and limited in the axial or longitudinal direction to about one wavelength of the light. Given that the shortest wavelength of visible light is about 400 nm, imaging specimen features smaller than this is problematic. Nonetheless, there is considerable interest in being able to capture nan-scale images of biological specimens and articles of manufacture as their salient features can be 100 nm or less in size.

The gold standard for imaging surface features at the nanometer scale is the SEM, or scanning electron microscope. As shown in FIG. 1, a scanning electron microscope 1 consists of an enclosure 2 from which the air is evacuated resulting in a vacuum 3. Within the vacuum 3 an electron gun 5 generates an electron beam 6, centered on central axis 4 and which pass through an electromagnetic condenser lens 7. Condenser lens 7 collects and focuses the electrons within the electron beam 6 to a small diameter, at which point the focused electron beam 6 passes through an aperture 8 that reduces the width of the electron beam further. The electron beam 6, now diverging after passing through aperture 8, passes through an electromagnetic focusing lens 9 which focuses and sharpens the beam further. The electron beam 6 exiting from focusing lens 9 then passes through a second aperture 10 before passing through deflection coils 11A and 11B. Deflection coils 11A and 11B cause the electron beam 6 to scan, such as in a raster pattern, in the X and Y directions across a sample 14. The diameter of the electron beam 6 at the sample 14 can be as small as a nanometer, which determines the resolution of the images of the sample 14 produced by the SEM 1. Electrons within the electron beam 6 strike the sample 14 and produce secondary electrons 15 in accordance with the topography of the sample 14 and the position of the electron beam 6 striking the sample 14. These secondary electrons 15 are detected by secondary electron detector 12, and the electronic signal is amplified and processed to generate a high-resolution image of the surface of the sample 14.

Note that sample 14 must be dry and free of water, or any other liquid that would out-gas or evaporate when brought under a vacuum. Further, the sample 14 must be electrically conductive and grounded to prevent the build-up of an electronic charge on sample 14 which will act to interfere with the electronic beam 6 striking sample 14 and thereby reduce the resolution of the SEM 1. Typically, a sample 14 can be made conductive by applying a thin layer of metal onto its surface. Also, since it takes time to draw a vacuum inside the SEM 1, the SEM's 1 utilization rate suffers as well. These drawbacks, and the fact that an SEM 1 cannot capture imagery, such as three-dimensional imagery, of the inside of a volumetric sample, have been found to limit its usefulness.

### SUMMARY

An imaging system includes a displacement measurement probe device, a mounting stage, and a processing system. The displacement measurement probe device is configured to make one or more displacement measurements with respect to a sample. The mounting stage is configured to support the sample, wherein at least one of the displacement measurement probe device or the mounting stage further comprises a rotatory actuator configured to rotate the one of the displacement measurement probe device or the mounting stage. The processing system is coupled to at least one of the displacement measurement probe or the mounting system and comprises a memory coupled to a processor which is configured to be capable of executing programmed instructions comprising and stored in the memory to: initiate the one or more displacement measurements with the displacement measurement probe; initiate with the rotary actuator a change in a rotational position of the sample on the mounting system relative to the displacement measurement probe for the one or more of the displacement measurements; determine a lateral position of features of the sample based on the displacement measurements and the different rotational positions; and generate at least a two-dimensional image of the sample based on the determined lateral position of the features of the sample.

A method for making an imaging system includes providing a displacement measurement probe device configured to make one or more displacement measurements with respect to a sample. A mounting stage configured to support the sample is provided, wherein at least one of the displacement measurement probe device or the mounting stage further comprises a rotatory actuator configured to rotate the one of the displacement measurement probe device or the mounting stage. A processing system is coupled to at least one of the displacement measurement probe or the mounting system and comprises a memory coupled to a processor which is configured to be capable of executing programmed instructions comprising and stored in the memory to: initiate the one or more displacement measurements with the displacement measurement probe; initiate with the rotary actuator a change in a rotational position of the sample on the mounting system relative to the displacement measurement probe for the one or more of the displacement measurements; determine a lateral position of features of the sample based on the displacement measurements and the different rotational positions; and generate at least a two-dimensional image of the sample based on the determined lateral position of the features of the sample.

A nanoscale imaging system for imaging a microscopic object consists of a highly accurate displacement-measuring probe and a rotational stage on which the microscopic object is mounted. The displacement-measuring probe is capable of measuring the longitudinal elevations of all features of a surface, or displacements to all features within a sample volume, concurrently, but is generally unable to localize the features laterally. Examples of the this technology are able to localize features laterally such that an image can be constructed of the surface or sample volume. By rotation the surface or sample volume about an axis other than the probe's optical axis, in a known manner, a change in displacement of the features can be effected and measured. After a suitable number of sample rotations the lateral position of the features can also be determined with great accuracy through the application of simple geometry and mathematical processing. Once the lateral and longitudinal positions of all the features are determined, an image of the surface or sample volume can be constructed, and furthermore, the precise numerical distance between the features is known as well. Utilizing a displacement-measuring probe with sub-nanometer accuracy can yield detailed imagery at the nanometer scale.

Additionally, examples of the nanoscale imaging system do not need to operate in vacuum conditions, the sample does not need to be stained or coated with a conductive material to be imaged, and the imaging can be either of a surface sample or a volumetric sample.

Accordingly, examples of the claimed technology provide a number of advantages including: providing an ultra-high resolution surface imaging system; providing an ultra-high resolution surface imaging system with numerical localization of features within the surface; providing an ultra-high resolution volumetric imaging system; and providing an ultra-high resolution volumetric imaging system with numerical localization of features within the volume.

### BRIEF DESCRIPTION OF THE DRAWINGS

FIG. 1 is an illustration of a prior art scanning electron microscope for nanoscale surface imaging;

FIG. 2 is a diagram of a nanoscale imaging system in accordance with examples of this technology;

FIG. 3 is a partial diagram of a confocal chromatic interferometric displacement measuring system;

FIG. 4A is a wavelet spectral interference pattern output by a spectrometer of a confocal chromatic interferometric displacement measuring system wherein there is one surface in the system's imaging field;

FIG. 4B is a dual-wavelet spectral interference pattern output by a spectrometer of a confocal chromatic interferometric displacement measuring system wherein there are two surfaces, of different displacement, in the system's imaging field;

FIG. 5 is a close-up view of the chromatic optical system and its associated chromatic focal region;

FIG. 6 is a close-up view of the chromatic focal region;

FIG. 7 is a close-up view of the chromatic focal region in which a test object having an illustrative surface having a piecewise linear cross-section has been inserted;

FIG. 8 is a close-up view of the chromatic focal region in which illustrative points of a surface under test are shown at three rotational positions;

FIG. 9 is a close-up view of the chromatic focal region in which fiducial objects are introduced to facilitate localization of points or features of a test surface or volume; and

FIG. 10 is a close-up view of the chromatic optical system and its associated chromatic focal region in which a fluid fills the space between the chromatic lens and test object to increase the numerical aperture of the optical system.

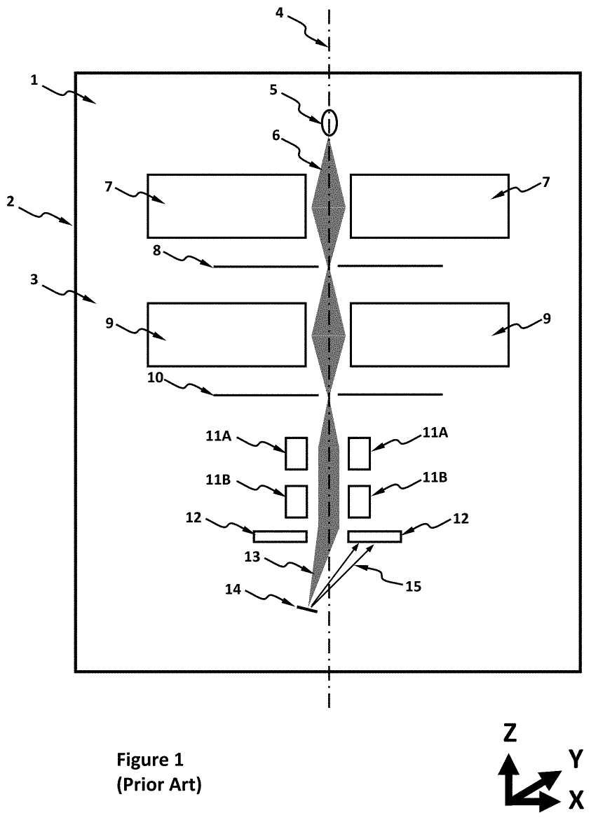

### DETAILED DESCRIPTION

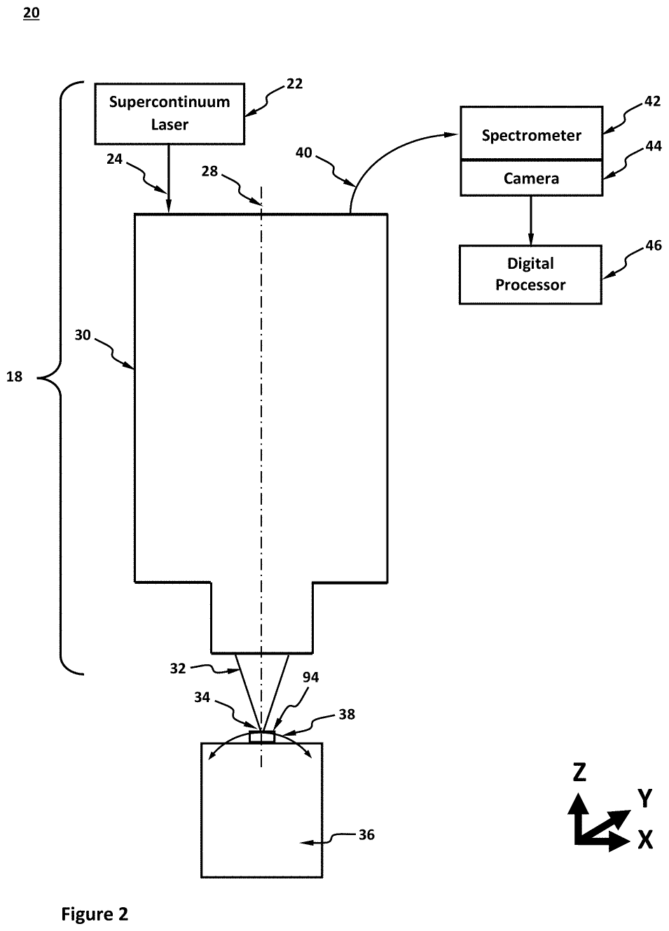

A functional block diagram of a nanoscale imaging system 20 in accordance with examples of this technology is illustrated in FIG. 2. In this example, the nanoscale imaging system 20 comprises a nanometric probe system 18 and a rotation stage 36 on which is mounted a test object 94 to be imaged, although the system could comprise other types and/or numbers of other systems, devices, components and/or other elements in other configurations. Accordingly, examples of the claimed technology provide a number of advantages including: providing an ultra-high resolution surface imaging system; providing an ultra-high resolution surface imaging system with numerical localization of features within the surface; providing an ultra-high resolution volumetric imaging system; and providing an ultra-high resolution volumetric imaging system with numerical localization of features within the volume.

Referring more specifically to FIG. 2, the nanometric probe system 18 comprises a supercontinuum laser light source 22, a source fiber 24, a probe device 30 having an optical axis 28, an output fiber 40, a spectrometer 42 coupled to a camera 44, and a digital processing system 46, although the probe system could comprise other types and/or numbers of other systems, devices, components and/or other elements in other configurations. In this example, the nanometric probe system 18 is a chromatic confocal interferometric displacement-measuring device that is capable of measuring a distance to a surface or a segment of a surface with great accuracy. In particular, the exemplary nanometric probe system 18 depicted in FIG. 2 is theoretically capable of measuring surface displacement of a sample or test object with one-tenth nanometer accuracy and is capable of resolving adjacent surfaces along its measurement axis that are as little as one nanometer apart.

In this example, the supercontinuum laser light source 22 is a “white light” supercontinuum laser that produces broadband light which is output into the source fiber 24, although other types of light sources in other configurations can be used. Additionally, in this example the source fiber 24 is a single-mode fiber optic that delivers the broadband light from the supercontinuum laser 22 light source to the probe device 30. The output fiber 40 is configured to receive the output broadband reference light which is then transmitted through output fiber 40 to the spectrometer 42 for interference with measurement light as described herein.

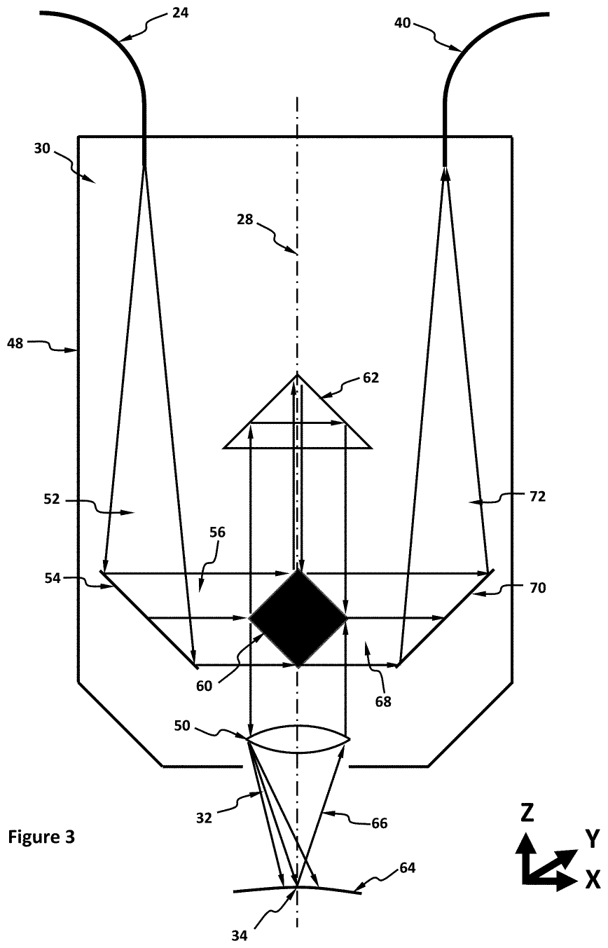

As shown in FIG. 3, the probe device 30 comprises an enclosure 48, source arm right angle parabolic mirror (RAPM) 54, mirrored beamsplitter 60, right angle prism 62, chromatic lens 50 which can be a multi-element lens system, and output arm RAPM 70, although the probe device could comprise other types and/or numbers of other systems, devices, components and/or other elements in other configurations. Source arm RAPM 54 is positioned to receive light exiting from the source fiber 24 that is diffracting outwardly to form a diverging entrance beam 52 and which collimates the beam into collimated source light 56 that is positioned to reflect towards beamsplitter 60. A first reflective facet of beamsplitter 60 is positioned to reflect the upper portion of collimated source light 56 to become incident upon the hypotenuse of right angle prism 62. The right angle prism 62 is positioned so that the upper portion of collimated source light 56 passes through the hypotenuse and is incident on a first short side of right angle prism 62 whereupon it totally-internally-reflects (TIRs) and becomes incident on a second short side of right angle prism 62 whereupon it again TIRs and exits right angle prism 62 through its hypotenuse. A third reflective facet of beamsplitter 60 is positioned to receive the light that exits right angle prism 62 which is reflected onto output arm RAPM 70. Output arm RAPM 70 is positioned to reflect the reference light and cause it to converge into converging output light 72 which then comes to a focus at an input aperture of output fiber 40. A second reflective facet of beamsplitter 60 is positioned to reflect a lower portion of collimated source light 56 to become incident upon chromatic lens 50 which causes the collimated light to become focused in a spectrally dispersed manner as chromatic measurement light 32. Chromatic lens 50 is positioned so that well-focused wavelength reflected from test surface 64 re-enters chromatic lens 50 which then re-collimates it and directs it onto a fourth reflective facet of beamsplitter 60. The fourth reflective facet of beamsplitter 60 is positioned to reflect the collimated measurement light on the output arm RAPM 70 which is positioned to reflect the measurement light and cause it to converge into converging output light 72 which then comes to a focus at an input aperture of output fiber 40 which directs this light to the spectrometer 42.

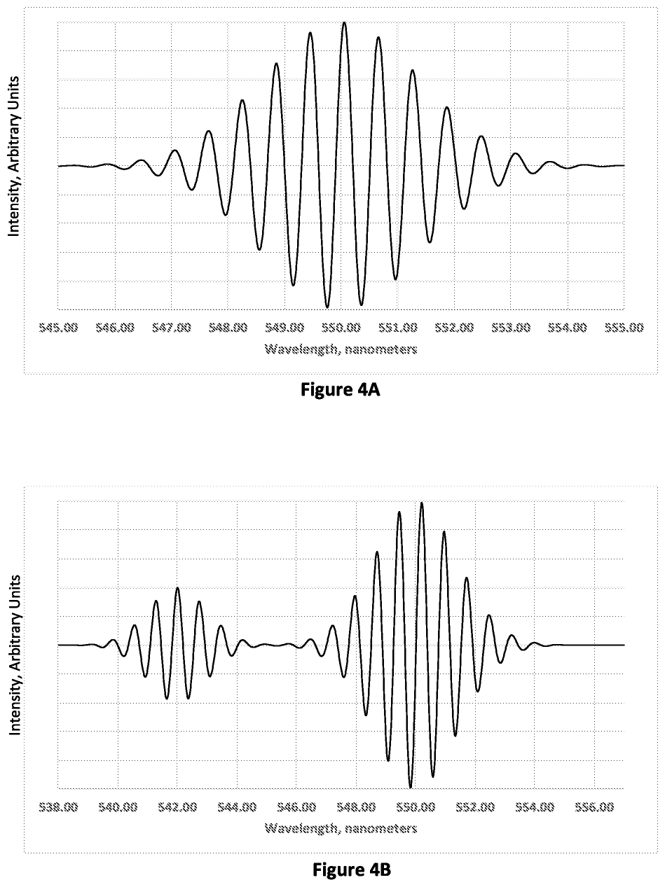

The spectrometer 42 is an optical instrument that is used to spectrally disperse an the reference and measurement light and presents an image of the dispersed light on the image sensor of a camera 44. By way of example, the dispersed reference and measurement light interfere and form an interference pattern such as the spectral wavelet pattern depicted in FIG. 4A, which is presented onto the image sensor of camera 44 coupled to spectrometer 42.

Camera 44 then captures the image of the spectral interferogram and transmits the spectral image to a digital processing system 46 which then processes the wavelet and determines the central wavelength of the interference pattern. This determined central wavelength is a proxy for the displacement to the test surface 64 in focal region 34, as the greater the central wavelength the greater the displacement.

The digital processing system 46 may include one or more processors, a memory, and/or a communication interface, which are coupled together by a bus or other communication link, although the digital processing system 46 can include other types and/or numbers of elements in other configurations and also other types of processing systems may be used. In this example the digital processing system 46 is coupled to execute programmed instructions as illustrated and described by way of the examples herein to control and manage the operation of the supercontinuum laser 22, the probe device 30, and/or the rotation stage 36, although the digital processing system 46 could be coupled to an interacting with other types and/or numbers of other systems, devices, components or other elements in other configurations. Additionally, in this example the digital processing system 46 is wireless coupled to control and manage the operation of the supercontinuum laser 22, the probe device 30, and the rotation stage 36, although other types of connections and/or communications mechanisms may be used, such as a hard wire connection.

The processor(s) of digital processing system 46 may execute programmed instructions stored in the memory for the any number of the functions described and illustrated herein. The processor(s) of digital processing system 46 may include one or more CPUs or general purpose processors with one or more processing cores, for example, although other types of processor(s) can also be used although the digital processing system 46 may comprise other types and/or numbers of components and/or other elements in other configurations.

The memory of the digital processing system 46 stores these programmed instructions for one or more aspects of the present technology as described and illustrated herein, although some or all of the programmed instructions could be stored elsewhere. A variety of different types of memory storage devices, such as random access memory (RAM), read only memory (ROM), hard disk, solid state drives, flash memory, or other computer readable medium which is read from and written to by a magnetic, optical, or other reading and writing system that is coupled to the processor(s), can be used for the memory.

The communication interface of the digital processing system 46 operatively couples and communicates to the spectrometer 42 and to the camera 44 by a communication system, although other types and/or numbers of communication systems with other types and/or numbers of connections and/or configurations to other devices and/or elements can also be used.

Examples of one or more portions of the claimed technology as illustrated and described by way of the examples herein may also be embodied as one or more non-transitory computer readable media having instructions stored thereon for one or more aspects of the present technology, such as the memory of the digital processing system 46. The instructions in some examples include executable code that, when executed by one or more processors, such as the processor(s) of the digital processing system 46, cause the one or more processors to carry out steps necessary to implement the methods of the examples of this technology that are described and illustrated by way of the examples herein.

In this example, the rotation stage 36 comprises a motorized structure on which a sample volume 94 or surface to be imaged or measured is installed in focal region 34 and is capable, with a rotary actuator in the rotation stage 36 operating in response to instructions from the digital processing system 46, of rotating the sample volume or surface to be measured within focal region 34, such as along rotation path 38. Additionally, in this example the rotation stage 36 is configured to rotate the sample volume or surface to be measured about a Y-axis as depicted in FIG. 2, and/or about an X-axis, but as will be discussed later not about an axis that is substantially parallel to the optical axis 28 of probe device 30 such as the Z-axis. Nonetheless, the number of rotational axes of rotation stage 36 can be one, two, or even three. It should be mentioned that instead of rotating the sample volume or surface to be measured with rotational stage 36, it is possible in other examples to instead couple rotational stage 36 to the probe device 30 and rotate probe device 30, with a rotary actuator for the probe device 30 in response to instructions from the digital processing system 46, about an otherwise stationary sample volume or surface. A surface under test 64 whose displacement or surface topography is to be measured is installed under nanometric probe system 18 within a focal region 34 as will be described later.

The operation of nanometric probe system 18 will now be described with reference to FIGS. 2 and 3. In this example, in operation the “white light” supercontinuum laser 22, in response to instructions from the digital processing system 46, produces broadband light and outputs it into source fiber 24. Source fiber 24 is a single-mode fiber optic that delivers the broadband light from the supercontinuum laser 22 light source to the probe device 30. Within the probe device 30 light exits from the source fiber 24 and diffracts outwardly forming diverging entrance beam 52, which is also broadband. Diverging entrance beam 52 is then incident upon source arm RAPM 54, which collimates the beam into collimated source light 56 and reflects it towards beamsplitter 60.

The upper portion of collimated source light 56 reflects from a first reflective facet of beamsplitter 60 and becomes incident upon the hypotenuse of right angle prism 62, passes through the hypotenuse and is incident on a first short side of right angle prism 62 whereupon it totally-internally-reflects (TIRs) and becomes incident on a second short side of right angle prism 62 whereupon it again TIRs and exits right angle prism 62 through its hypotenuse. This light that exits right angle prism 62 is incident on a third reflective facet of beamsplitter 60, and while still collimated and broadband, this reference light is incident on output arm RAPM 70. Output arm RAPM 70 then reflects the reference light and causes it to converge into converging output light 72 which then comes to a focus at an input aperture of output fiber 40. Output broadband reference light is then transmitted through output fiber 40 to spectrometer 42 for interference with measurement light as described below.

The lower portion of collimated source light 56 reflects from a second reflective facet of beamsplitter 60 and becomes incident upon chromatic lens 50 which causes the collimated light to become focused in a spectrally dispersed manner as chromatic measurement light 32. Note that the focal position of chromatic measurement light 32 on optical axis 28 is a function of wavelength, with shorter wavelengths generally coming to a focus closer to chromatic lens 50 than the longer wavelengths. A test surface 64 of unknown displacement relative to the probe device 30 is positioned within the focal region 34 of chromatic measurement light 32 such that one of the wavelengths within chromatic measurement light 32 is well-focused on test surface 64. The well-focused wavelength is reflected from test surface 64 as reflected measurement light 66 which then re-enters chromatic lens 50 which then re-collimates it and directs it onto a fourth reflective facet of beamsplitter 60. The collimated measurement light is then reflected from the beamsplitter 60, and while still collimated—but nearly monochromatic—is also incident on output arm RAPM 70. Output arm RAPM 70 then reflects the measurement light and causes it to converge into converging output light 72 which then comes to a focus at an input aperture of output fiber 40. The narrowband measurement light entering output fiber 40 is then transmitted through output fiber 40 the spectrometer 42 for interference with the reference light.

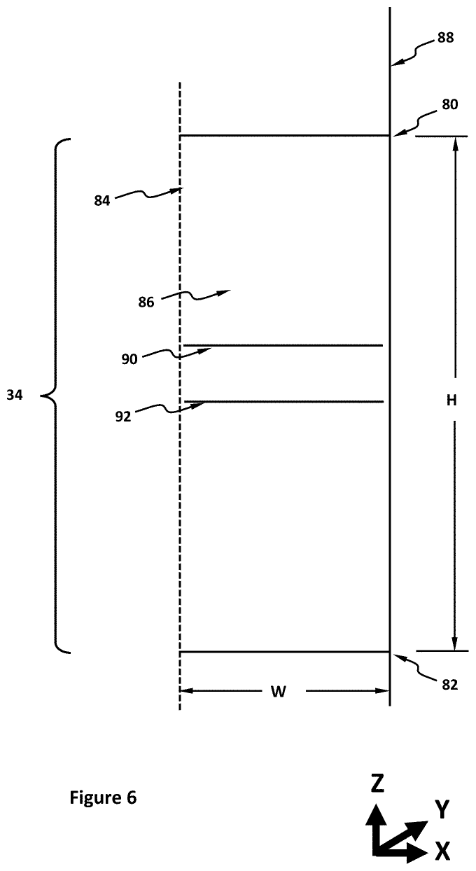

The spectrometer 42 spectrally disperses the reference and measurement light and presents an image of the dispersed light on the image sensor of a camera 44. Further, the dispersed reference and measurement light interfere and form an interference pattern, such as the spectral wavelet pattern depicted in FIG. 4A, which is presented onto the image sensor of camera 44 coupled to spectrometer 42. Camera 44 then captures the image of the spectral interferogram and transmits the spectral image to a digital processing system 46 which then processes the wavelet and determines the central wavelength of the interference pattern. This determined central wavelength is a proxy for the displacement to the test surface 64 in focal region 34, as the greater the central wavelength the greater the displacement. Indeed, once fully calibrated, in which the relationship between central wavelet wavelength and displacement is determined, the displacement can be determined with great accuracy and resolution, such as less than one nanometer. Owing to the ability to localize the central wavelength of the wavelet with great accuracy, the ratio of the depth of the measurement range (the quantity H, as discussed later in connection to FIG. 6) to the displacement measurement accuracy can be on the order of 10⁷. This means, for example, that if the measurement range of probe 18 is set to the anticipated peak-to-valley depth of a surface (or set to the thickness of a sample volume) of 1.00 mm, then the displacement measurement accuracy of a surface or point within that 1.00 mm range is 1.00 mm/10⁷=100 pm.

In addition to its great displacement-measuring accuracy, another feature of examples of the nanometric probe system 18 is its ability to accurately measure displacement to more than one surface within focal region 34 simultaneously. For example, if a second surface is in focal region 34 it will produce a second wavelet in the interferogram, resulting in an interferogram similar to that of FIG. 4B. It is then a simple matter for digital processing system 46 to process and analyze the dual-wavelet interferogram and determine the central wavelength of each and numerically compute the distance between the surfaces with nanometer-scale accuracy. Note further that the two wavelets of FIG. 4B have different amplitudes, which can be indicative of the relative reflectivities of the two surfaces. As will be discussed later this amplitude information can be used to beneficially determine the relative brightness of an object within a gray-scale 2D or 3D image produced by nanometer scale imaging system 20.

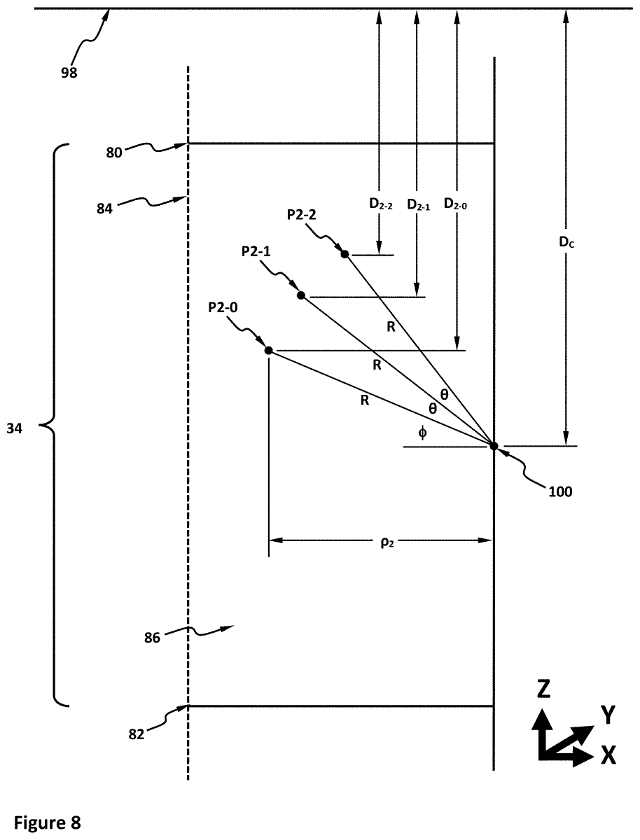

Note that displacement as used herein is a distance from a reference plane (such as reference plane 98 shown in FIG. 8, as will be discussed later) associated with nanometric probe system 18 to the surface under test 64 along optical axis 28 or along a line parallel to optical axis 28. Further, optical axis 28 is defined to be substantially parallel to the Z-axis. Accordingly, this example of the nanometric probe system 18 can produce elevation or displacement values of any features of surface under test 64 or surface 96.

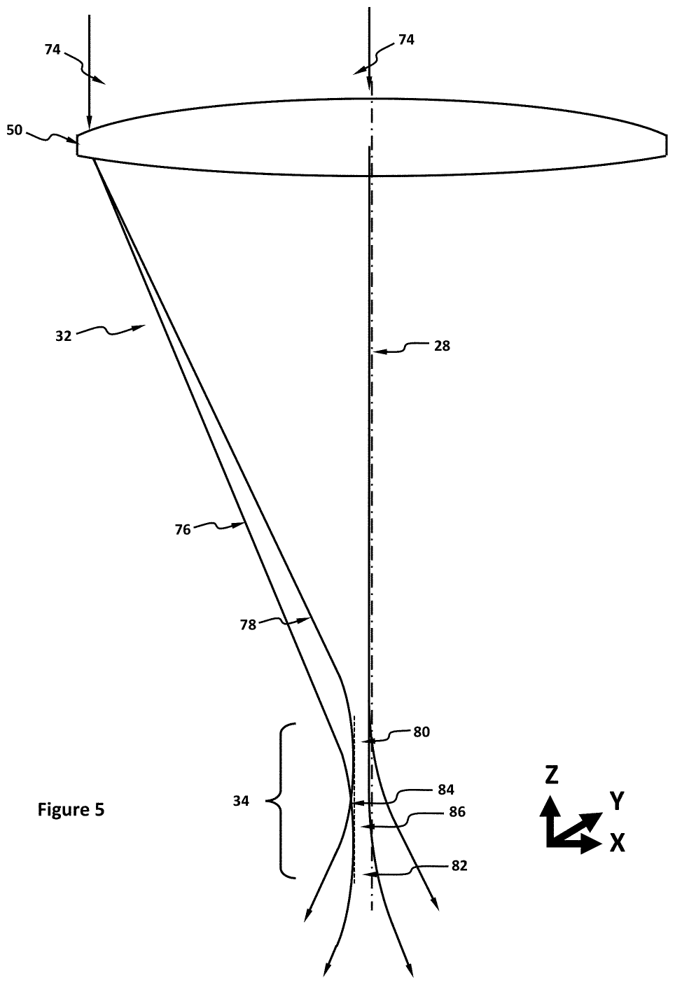

Referring now to FIG. 5, an example of how the exemplary confocal chromatic interferometric displacement-measuring nanometric probe system 18 described above, utilizes chromatic measurement light 32 in which, typically, the shorter wavelengths of light are brought to a focus closer to chromatic lens 50 than the longer wavelengths of light. A surface under test having a smaller displacement will typically have a shorter wavelength of chromatic measurement light 32 in focus on its surface, while a surface under test having a larger displacement will typically have a longer wavelength of chromatic measurement light 32 in focus on its surface. Indeed, as shown in FIG. 5, which is a close-up view of the chromatic lens 50 and its associated chromatic focal region 34, a short wavelength measurement light ray 78 forms a focus at short wavelength focal plane 80 (also shown in FIG. 6) which is closer to chromatic lens 50 than a long wavelength focal plane 82 associated with long wavelength measurement light ray 76. Note that at the best focus for each wavelength the focus is not a point, but has a non-zero width W (as defined in FIG. 6) caused by diffraction and aberrations and defects associated with chromatic lens 50, or by design. The left side of the envelope of focal planes over all utilized wavelengths is denoted by the dotted line in FIGS. 5 and 6, the chromatic light focus envelope boundary 84. The nanometric probe system 18 is operative with a test object, surface, or volume located in a focal zone 86 which is that space between short wavelength focal plane 80 and long wavelength focal plane 82 and inboard of chromatic light focus envelope boundary 84.

Referring more particularly to FIG. 6, focal zone 86 has a height H, corresponding to the height of focal region 34 which, again, is that space between short wavelength focal plane 80 and long wavelength focal plane 82, and a width W, defined to be the lateral distance (e.g., in the X-direction) between chromatic light focus envelope boundary 84 and a right boundary of focal region 88 outside of which the chromatic measurement light 32 is dim or otherwise unusable.

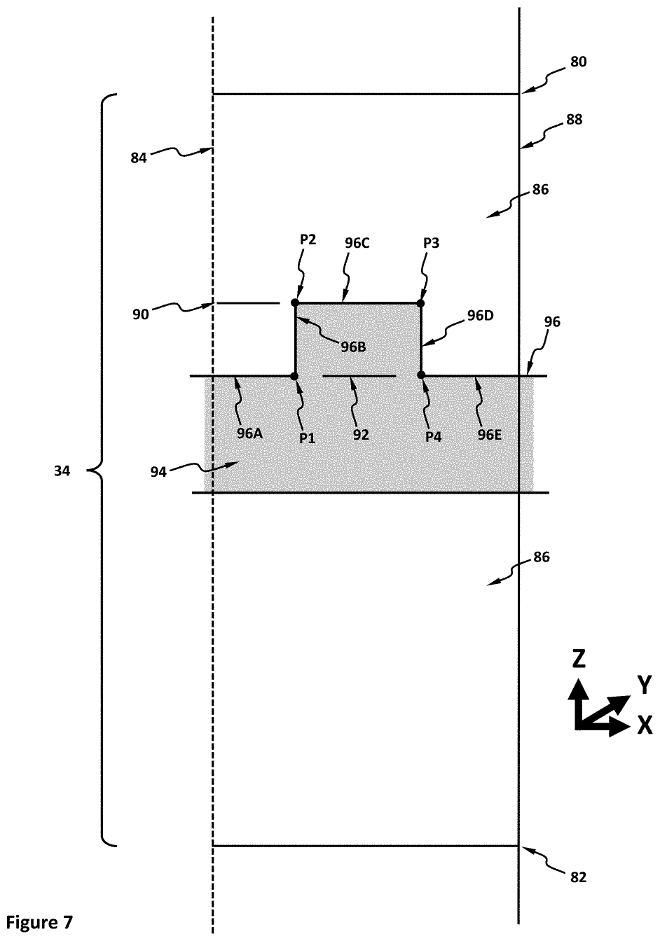

FIG. 7 is a close-up view of the focal zone 86 in which a test object 94 having an illustrative surface 96 having a piecewise linear cross-section has been inserted. For simplicity surface 96 comprises five planar surface segments, 96A through 96E, separated by four edges. In the cross-section of test object 94 in FIG. 7 the four edges are depicted as points P1, P2, P3, and P4. Note further that nanometric probe system 18 will be able to determine the displacement of upper surface segment 96C, corresponding to the focal plane of wavelength 90, and lower surface segments 96A and 96E, corresponding to the focal plane of wavelength 92, but not the lateral position of segment 96B and segment 96D. That is, nanometric probe system 18 will be able to deduce the Z-position of points P1 through P4, but not their lateral X or Y-position.

An exemplary nanoscale imaging system 20, as shown in FIG. 2, is a metrology system that is advantageously capable of overcoming the limitations of a displacement-measuring nanometric probe system 18, in which the lateral X and Y positions of features within a surface or volume, such as illustrative points P1 through P4 of FIG. 7 cannot be discerned. Nanoscale imaging system 20 comprises a displacement measuring probe, such as confocal chromatic interferometric nanometric probe system 18, and a rotation stage 36 on which a sample volume 94 or surface to be imaged or measured is installed in focal region 34.

The operation of examples of this technology will now be described with reference to FIG. 8. As seen in FIG. 8, point P2-0 is the same as point P2 of FIG. 7 when the rotation stage 36 is at its null, baseline, or otherwise zero-angle angular position. Also, the position of the axis of rotation 100 of rotation stage 36 is shown as being to the side of focal zone 86, although it can be inside focal zone 86, or outside focal zone 86. An axis of rotation 100 also implies that rotation stage 36 only rotates about one axis, whereas in reality rotation stage 36 could instead rotate about two axes or even three axes. For simplicity and clarity of explanation in this example the axis of rotation 100 will be assumed to be parallel to the Y-axis, and all points and construction lines will reside in the X-Z plane. Note, however, that reference plane 98, which is that plane from which all measured displacements are computed from, will reside in a plane parallel to the X-Y plane, although for clarity of explanation herein the reference plane 98 is projected onto a line that is parallel to the X-axis.

There are several other quantities in FIG. 8 that need to be defined. Specifically, θ is the amount of rotation, in degrees, that rotation stage 36 makes between displacement measurements of nanometric probe system 18. θ is assumed to be a constant value in the present description, although θ can vary from rotation to rotation of rotation stage 36. P2-1 is the location of P2 after the first rotation of θ degrees of rotation stage 36 and P2-2 is the location of P2 after the second rotation of θ degrees of rotation stage 36. The quantity R is the distance, or, more specifically the radial distance, from the axis of rotation 100 to P2-0, P2-1, and P2-2. At each position of P2, namely P2-0, P2-1, and P2-2, nanometric probe system 18 measures the displacement to its position, yielding measured quantities D₂₋₀, D₂₋₁, and D₂₋₂ respectively. Furthermore, axis of rotation 100 has a displacement associated with its position as well, denoted as D_{c} in FIG. 8. Quantity φ is that angle a line from the axis of rotation 100 to P2 makes with respect to the X-axis. Lastly, the position of P2-0 (i.e., P2) has an associated lateral distance from a reference line associated with it, that lateral distance being defined as ρ₂. Of these quantities D₂₋₀, D₂₋₁, and D₂₋₂ are known (because they are measured by the nanometric probe system 18), θ is known because the rotation stage 36 has been commanded to rotate by this amount, while R is unknown, φ is unknown, D_{c} is unknown, and ρ₂ is unknown. The goal is to find the lateral offset of P2, which essentially entails determining the value of ρ₂. However, the value of ρ₂ can be easily determined from the values of R and φ:

ρ₂=R cos φ Equation 1

Clearly once R and φ are determined it is a simple matter to compute ρ₂ and localize the lateral position of P2. The three unknown quantities, R, φ, and Dc can be found by constructing and simultaneously solving three independent equations. By inspection:

D₂₋₀=D_{c}−R sin φ Equation 2

D₂₋₁=D_{c}−R sin(φ+θ) Equation 3

D₂₋₂=D_{c}−R sin(φ+2θ) Equation 4

From equations 2, 3, and 4, the quantities R and φ can be computed from which the lateral position of P2 can be found from Equation 1.

As an example, if the rotation stage 34 is commanded to have θ=15°, and the three displacement readings are D₂₋₀=23.000 μm, D₂₋₁=20.000 μm, and D₂₋₂=17.500 μm, then equations 2, 3, and 4 are solved yielding R=12.9122 μm, D_{c}=27.3369 μm, and φ=19.626°. Plugging the values of R and φ into Equation 1 and solving yields ρ₂=12.1621 μm. In this way the lateral position of a point or location of a surface or volume can be determined with great precision from a series of longitudinal displacement measurements of that point resulting from a rotation of the surface or volume between displacement measurements.

It is important to note that while the preceding illustrative description was limited to a two-dimensional plane (i.e., the X-Z plane) for simplicity and clarity, the described localization process of a point can be generalized to a volume by a rotation of the test object 94 or sample volume about a second axis, and even a third axis as well, and generalizing Equations 1 through 4 to three-dimensional space. Additionally, while the preceding illustrative example concerned the localization of a single point, it is important to realize that a sample volume or a surface of a test object can consist of a series of points, such as an array of pixels, if a surface, or an array of voxels, if a volume, and performing the above sequence of displacement measurements and rotations allows for the longitudinal and lateral localization of those points constituting a surface or a sample volume. After the points are localized, they collectively form a so-called point-cloud, which is essentially an image of the surface or sample volume. Furthermore, unlike many microscopic images, which are qualitative in nature, the precise quantitative (i.e., numerical) spatial relationships between the points constituting the image are determined and known with great precision.

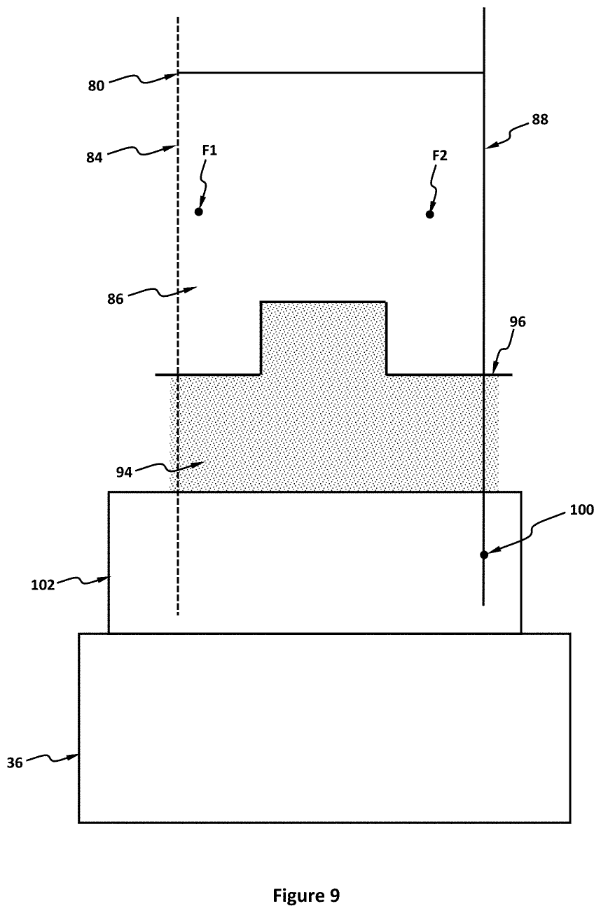

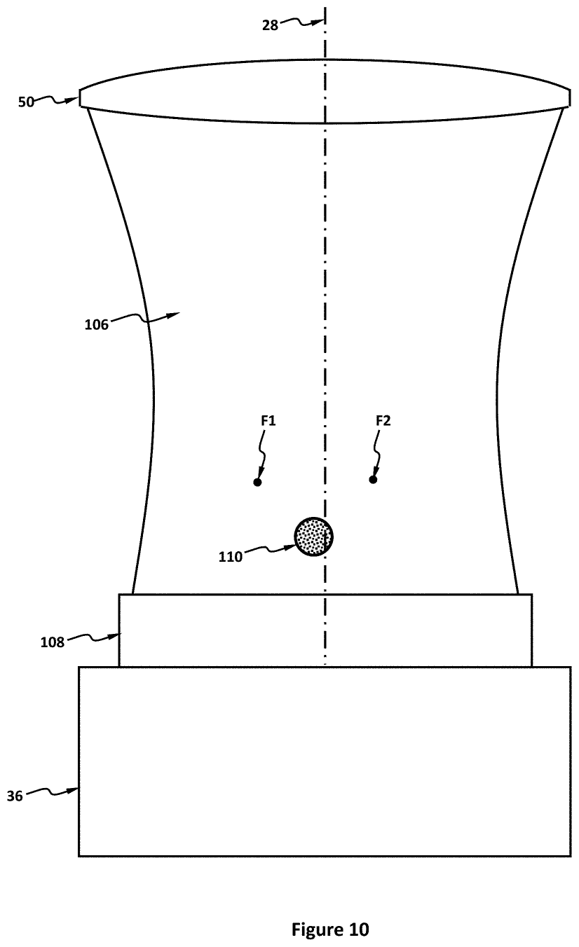

One potential problem with the embodiment of the nanoscale imaging system 20 described above is the ability of rotation stage 36 to rotate the test object 94 or sample volume about an axis of rotation 100 at a level of precision necessary for good lateral localization of the points comprising the test surface or sample volume. In actuality rotation stage 36 will have mechanical defects or other limitations which will cause the rotation axis 100 or point to objectionably vary or move during a rotation or between rotations. Furthermore, when rotation stage 36 is commanded to rotate by an amount of θ degrees it will in actuality rotate an amount of θ plus or minus some undesirable tolerance. Both of these limitations will limit the lateral localization determination of the points comprising a test surface or sample volume. However, these limitations can be accounted for and their associated localization errors corrected by introducing fiducial objects in the focal zone 86. As illustrated in FIG. 9, test object 94 having surface 96 is installed onto mount 102 which in turn is coupled to rotation stage 36. A plurality of fiducial objects, such as fiducial objects F1 and F2, are placed or otherwise installed in the focal zone 86 above surface 96, and the spatial relationship between them, while not necessarily known, is fixed during the process of imaging surface 96. Defects in the rotation process will affect the angular and translational positioning of fiducial objects F1 and F2, which can be tracked. Since the spatial relationship between fiducial objects F1 and F2 is fixed, the angular and translational defects attributed to rotation stage 36 can be determined, and the determined errors subtracted from or otherwise removed from the lateral positioning calculation of the points comprising test surface 96 (or a sample volume). Rotation stage 36 can also be outfitted with translational motion capabilities to mechanically compensate for spurious translational movements of rotation axis 100, or the rotation point, during the process of rotation, such that, for example, the location of rotation axis 100, or the rotation point, does not materially shift in position between displacement measurements.

The number of fiducial objects can be between three and 1000, and they can range in size from having a width from 10 nm up to 10 μm. If the object being imaged is a volumetric sample, the fiducial objects can be placed above, alongside, or even below the sample volume.

An additional variation of examples of this technology is to install an immersion fluid 106 between the chromatic lens 50 and the lower object mount, such as immersion mount 108, such that a test object 110, or test surface, or sample volume, to be imaged is fully immersed in the immersion fluid 106. The immersion fluid 106 has the benefit of increasing the numerical aperture of the chromatic lens 50 which in turn reduces the diffraction effects associated with chromatic lens 50 and can reduce the width W of the focal zone 86. The immersion fluid 106 can be an aqueous solution, or an organic liquid, but in general the higher the refractive index of immersion fluid 106 the smaller width W can be. Under best circumstances, with an optically fast and well corrected chromatic lens 50, W can be as small as 0.5 μm with the use of an immersion fluid 106.

At the other extreme, W can be as large as 1.0 mm without the use of an immersion fluid 106 and in which chromatic lens 50 is optically slow or otherwise designed to achieve a large focal zone 86 width W. The height H of the focal zone 86 can also be tailored as well, being as small as 0.5 μm with an optically fast and well corrected chromatic lens 50 with the use of an immersion fluid 106, or as large as 25 millimeters without the use of an immersion fluid 106 and when chromatic lens 50 is optically slow or otherwise designed to achieve a large focal zone 86 height H. During the imaging process the number of rotations made by rotation stage 36 can be between two and 2,000,000 for each axis of rotation.

Note that the nanometric probe system 18 has been described as being a confocal chromatic interferometric probe, beneficially combining the high accuracy of interferometry, concurrent multi-displacement metrology of a chromatic probe, and the longitudinal and lateral spatial discrimination of a confocal system. However, nanometric probe system 18 can incorporate any, or all, or none of these optical techniques, as long as nanometric probe system 18 can measure displacement to one or more levels in a test volume accurately and concurrently.

Note that the location of the features of a surface or volumetric object that is imaged by the nanoscale imaging system are known, numerically, with great precision. More specifically, the nanometric probe system 18 can measure the Z-dimension of the features of these specimens to great precision just by virtue of its function, and by virtue of the rotational stage 36, equations 1 through 4, and the algorithm described above, the X and Y location of these features can be calculated to great precision as well. Knowing the X, Y, and Z location of these features relative to one another allows for a precise topographical map of a surface, or a 3D image composed of these features, to be created with great precision. These images can be expressed numerically, as for example, a 2D or 3D array of numbers for computational analysis, or visually in which a rendered 2D or 3D image is fabricated from these numerically-defined points for viewing by a user. Indeed, the images produced by nanoscale imaging system 20 are typically comprising voxels, or volume picture elements, wherein the width of the voxels are in accordance with the resolution of the image. That is, the smaller the voxel size the smaller (i.e., the better) the resolution the of the image. The widths of the voxels produced by the nanoscale imaging system 20 can be as small as 100 nm, 10 nm, or even 1 nm across.

Applications for the nanoscale imaging system 20 abound and include three-dimensional imaging of specimens and large molecules in-vitro, without the need for coating or staining the specimen, or drawing a vacuum about the specimen. Test object surfaces that can be beneficially imaged by examples of this technology include semiconductors, optical devices, and other articles of manufacture. Biological specimens, such as viral and bacterial organisms, can have their surfaces imaged or their internal volumes imaged in three-dimensions, both qualitatively and numerically and with high resolution, precision, and accuracy. Indeed, it is quite possible that large biological molecules such as RNA, DNA, and certain proteins can be directly imaged as they reside in their native organism.

Having thus described the basic concept of the invention, it will be rather apparent to those skilled in the art that the foregoing detailed disclosure is intended to be presented by way of example only and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations, such as arrows in the diagrams therefore, is not intended to limit the claimed processes to any order or direction of travel of signals or other data and/or information except as may be specified in the claims. Accordingly, the invention is limited only by the following claims and equivalents thereto.

What is claimed is:

1. An imaging system comprising:
a displacement measurement probe device configured to make one or more displacement measurements with respect to a sample;
a mounting stage configured to support the sample, wherein at least one of the displacement measurement probe device or the mounting stage further comprises a rotatory actuator configured to rotate the one of the displacement measurement probe device or the mounting stage; and
a processing system coupled to at least one of the displacement measurement probe device or the mounting system, wherein the processing system comprises a memory coupled to a processor which is configured to be capable of executing programmed instructions comprising and stored in the memory to:
initiate the one or more displacement measurements with the displacement measurement probe device; and
initiate with the rotary actuator a change in a rotational position of the sample on the mounting system relative to the displacement measurement probe device for the one or more of the displacement measurements;
determine a lateral position of features of the sample based on the displacement measurements and the different rotational positions; and
generate at least a two-dimensional image of the sample based on the determined lateral position of the features of the sample.

2. The system as set forth in claim 1 wherein the displacement measurement probe device is a confocal chromatic probe.

3. The system as set forth in claim 2 wherein the confocal chromatic probe is a confocal chromatic interferometric probe.

4. The system as set forth in claim 1 wherein the displacement measurement probe device is configured to make the one or more displacement measurements with respect to a sample comprising a surface.

5. The system as set forth in claim 4 wherein the processor is further configured to be capable of executing programmed instructions comprising and stored in the memory to:
determine a lateral position topography of the surface based on the determined lateral position of the features of the sample.

6. The system as set forth in claim 5 wherein for the determine the lateral position topography, the processor is further configured to be capable of executing programmed instructions comprising and stored in the memory to:
determine the lateral position topography of the surface wherein the topography of the surface is numerically imaged.

7. The system as set forth in claim 1 wherein the displacement measurement probe device is configured to make the one or more displacement measurements with respect to a sample comprising a volume.

8. The system as set forth in claim 7 wherein the processor is further configured to be capable of executing programmed instructions comprising and stored in the memory to:
determine a three-dimensional image of an interior of the volume based on the determined lateral position of the features of the sample.

9. The system as set forth in claim 8 wherein for the determine three-dimensional image of the interior of the volume, the processor is further configured to be capable of executing programmed instructions comprising and stored in the memory to:
determine the three-dimensional image of the interior of the volume, wherein the interior of the volume is three-dimensionally numerically imaged.

10. The system as set forth in claim 1 in which the probe has a measurement beam whose width is greater than the width of the sample.

11. The system as set forth in claim 1 wherein the displacement measurement probe device is further configured to have a measurement axis and wherein for the initiate with the rotary actuator the change in a rotational position of the sample, the processor is further configured to be capable of executing programmed instructions comprising and stored in the memory to:
initiate with the rotary actuator the change in the rotational position of the sample to rotate about an axis orthogonal to the measurement axis.

12. The system as set forth in claim 1 further comprising one or more fiducial elements configured to be installed in the sample.

13. The system as set forth in claim 1 wherein the generated at least the two-dimensional image of the sample comprises voxels.

14. The system as set forth in claim 13 wherein a width of one of the voxel is less than 100 nanometers.

15. The system as set forth in claim 13 wherein a width of one of the voxels is less than 10 nanometers.

16. The system as set forth in claim 13 wherein a width of one of the voxels is less than 1 nanometer.

17. A method for making an imaging system, the method comprising:
providing a displacement measurement probe device configured to make one or more displacement measurements with respect to a sample;
providing a mounting stage configured to support the sample, wherein at least one of the displacement measurement probe device or the mounting stage further comprises a rotatory actuator configured to rotate the one of the displacement measurement probe device or the mounting stage; and
coupling a processing system to at least one of the displacement measurement probe device or the mounting system, wherein the processing system comprises a memory coupled to a processor which is configured to be capable of executing programmed instructions comprising and stored in the memory to:
initiate the one or more displacement measurements with the displacement measurement probe device; and
initiate with the rotary actuator a change in a rotational position of the sample on the mounting system relative to the displacement measurement probe device for the one or more of the displacement measurements;
determine a lateral position of features of the sample based on the displacement measurements and the different rotational positions; and
generate at least a two-dimensional image of the sample based on the determined lateral position of the features of the sample.
